(19) United States
(12) Patent Application Publication
(10) Pub. No.: US 2011/0114068 A1
(43) Pub. Date: May 19, 2011

(54) ENGINE START-UP WITH A SECONDARY FUEL

(75) Inventors: Robert D. Habing, Albuquerque, NM (US); Jonathan M. Wong, Albuquerque, NM (US)

(73) Assignee: Honeywell International Inc., Morristown, NJ (US)

(21) Appl. No.: 12/618,266

(22) Filed: Nov. 13, 2009

(51) Int. Cl. F02B 1/00; F02N 9/00

(52) U.S. Cl. 123/576; 123/179.8

(57) ABSTRACT

An engine system includes a primary fuel source and a secondary fuel source. The secondary fuel source includes a secondary fuel with which the engine can be initially started in order to preheat the engine such that it is better able to combust the primary fuel. In some examples, the secondary fuel source is in-line with the primary fuel source, such that the first and secondary fuel sources share a fuel line that supplies fuel to the engine. In addition, in some examples, the secondary fuel source is removably attached to the fuel line, such that it can be removed from the fuel line in a relatively efficient manner.

### TECHNICAL FIELD

The disclosure relates to engines, and, more particularly, starting engines.

### BACKGROUND

A spark ignition engine initiates an internal combustion process that drives the generation of mechanical energy by igniting an air-fuel mixture with a spark, e.g., from a spark plug. Examples of spark ignition engines include two stroke and four stroke engines. In some operating conditions, such as when the spark ignition engine is cold (e.g., the internal temperature of the engine itself is relatively cold) or is operating in a relatively cold environment, it can be difficult to start the engine because the fuel may not readily vaporize, and, as a result, the air-fuel mixture in the combustion chamber may not have a sufficient amount of fuel for the spark to ignite.

### SUMMARY

In general, the disclosure is directed to techniques and structure for starting a spark ignition engine, e.g., when the engine is in a cold state (e.g., the temperature of the combustion chamber is lower than the temperature at which a primary fuel readily vaporizes) or when the engine is operating in a relatively cold environment. The engine generates mechanical energy by combusting a primary fuel with an oxidizer (e.g., air) in a combustion chamber of the engine. During engine start-up, a secondary fuel that is more volatile than the primary fuel and vaporizes more easily (e.g., at a lower temperature) than the primary fuel is introduced into the same fuel line that also introduces the primary fuel into the combustion chamber. The engine warms up by combusting the secondary fuel prior to combusting the primary fuel. The secondary fuel may be contained in a removable and/or disposable cartridge.

In one aspect, the disclosure is directed to a system comprising a spark ignition engine, a first fuel source that includes a first type of fuel, a second fuel source that includes a second type of fuel that is more volatile than the first type of fuel, a fuel injector that provides the fuel from the first and second fuel sources to the engine, wherein the second fuel source is positioned between the fuel injector and the first fuel source, and a fuel line that fluidically connects the first and second fuel sources with the fuel injector. The first and second fuel sources can be, for example, respective containers (also referred to as receptacles or canisters) that are physically separate from each other and each store a volume of fuel (e.g., liquid fuel).

In another aspect, the disclosure is directed to a system comprising a spark ignition engine, a first fuel source that stores a primary fuel, a second fuel source that stores a secondary fuel different than the primary fuel, and a pump that pumps the fuel from the first and second fuel sources to the engine. The first and second fuel sources are connected to the pump in series.

In another aspect, the disclosure is directed to a method comprising fluidically connecting a removable fuel source to a fuel line, wherein the fuel line fluidically connects a primary fuel source to an engine, starting the engine with a secondary fuel contained by the removable fuel source, and, after starting the engine with the secondary fuel, removing the removable fuel source from the fuel line. The engine runs on a primary fuel contained by the primary fuel source after removal of the removable fuel source from the fuel line.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a schematic illustration of an example engine system, which includes a primary fuel source and a removable secondary fuel source.

FIG. 2 is a schematic illustration of another example engine system, which includes a primary fuel source and a removable secondary fuel source.

FIG. 3 is a conceptual illustration of an example secondary fuel source that can be removably fluidically coupled to an engine.

FIG. 4 is a conceptual illustration of a secondary fuel source in fluid communication with a fuel line that fluidically connects a primary fuel source with a fuel injector of the engine system of FIG. 2.

FIG. 5 is a schematic illustration of another example engine system, which includes a secondary fuel source that interrupts a fuel line.

FIG. 6 is a schematic illustration of another example engine system, which includes a carburetor.

FIG. 7 is a flow diagram illustrating an example technique for starting a spark ignition engine.

### DETAILED DESCRIPTION

In general, the disclosure is directed to a system that includes a primary fuel source that stores (or contains) a primary fuel for operation of a spark ignition engine, and a secondary fuel source, which stores a secondary fuel that can be used to start the spark ignition engine. In some examples, the secondary fuel source is configured to be removably fluidically coupled (or fluidically connected) to a fuel line that also fluidically connects the primary fuel source to a combustion chamber of an engine. The primary and secondary may or may not share a fuel pump and/or a fuel injector.

The secondary fuel stored by the secondary fuel source vaporizes at a lower temperature than the primary fuel source. For example, the secondary fuel can be more volatile than the primary fuel. As a result, the secondary fuel source may help initiate an internal combustion process of the engine, e.g., under circumstances in which the initiation of the internal combustion process using the primary fuel from the primary fuel source is difficult or even impossible. In some examples, the primary fuel comprises a heavy fuel, such as diesel or a jet fuel, and the secondary fuel comprises a liquid gasoline-based fuel (e.g., gasoline, petroleum ether, a liquefied petroleum gas or other grades of gasoline).

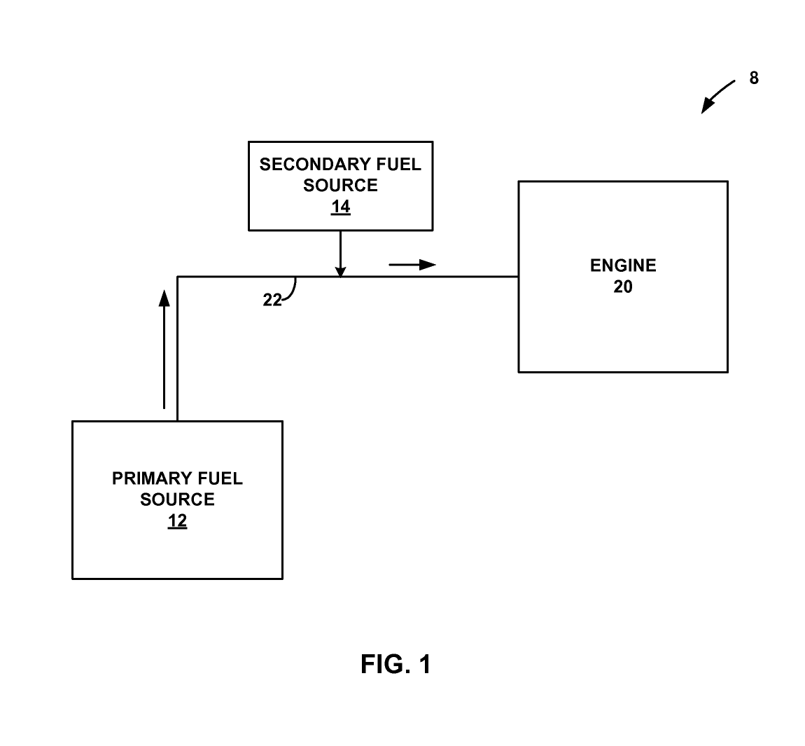

FIG. 1 is a schematic illustration of system 8, which includes first and second fuel sources, and, more particularly, primary fuel source 12 and secondary fuel source 14. System 8 further includes engine 20, which is configured to run on a primary fuel stored by primary fuel source 12, and further includes secondary fuel source 14 that helps initiate an internal combustion process during an initial start-up of engine 20. First and second fuel sources 12, 14, respectively, can be, for example, respective containers (also referred to as receptacles or canisters) that are physically separate from each other. First and second fuel sources 12, 14, respectively, each store a volume of fuel (e.g., liquid fuel).

In some examples, primary fuel source 12 is substantially permanently integrated into system 8, such that removal of primary fuel source 12 is difficult and requires substantial modification to system 8 with the use of tools. In addition, secondary fuel source 14 can be removably attached to system 8 (as indicated by the arrow between secondary fuel source 14 and fuel line 22 shown in FIG. 1), such that secondary fuel source 14 can be more easily removed from system 8 than primary fuel source 12. In some examples, secondary fuel source 14 can be physically separated from system 8 by a user without the aid of tools and without substantially damaging fuel line 22 or other portions of system 8. That is, system 8 can continue to operate even after secondary fuel source 14 is removed from system 8.

In some examples, engine 20 is, for example, a two-stroke or a four-stroke internal combustion engine, although other types of spark ignition engines are contemplated. In some examples, engine 20 includes a gasoline engine that is configured to operate using a heavy fuel. Examples of heavy fuels include, but are not limited to diesel fuel or jet fuel (e.g., JP5 or JP8). It may be desirable to modify a gasoline engine to run on a heavy fuel because the heavy fuel may provide more energy per unit volume than a gasoline-based fuel. In addition, with some organizations that operate fleets of vehicles, such as in a military environment, it can be more convenient to supply and store a single type of fuel for multiple types of engines.

One issue with a heavy fuel is that it is more difficult to burn. The heavy fuel can be difficult to burn because the heavy fuel may not vaporize as readily and may be less volatile than as a gasoline-based fuel. Secondary fuel source 14 described herein helps overcome some of the disadvantages associated with starting engine 20 that operates using a heavy fuel. In particular, as described in further detail below, secondary fuel source 14 provides a secondary fuel with which engine 20 runs for a relatively short period of time (e.g., less than about 10 minutes, such as about one to two minutes) in order to prime engine 20 to better burn (or combust) a primary fuel, e.g., a heavy fuel.

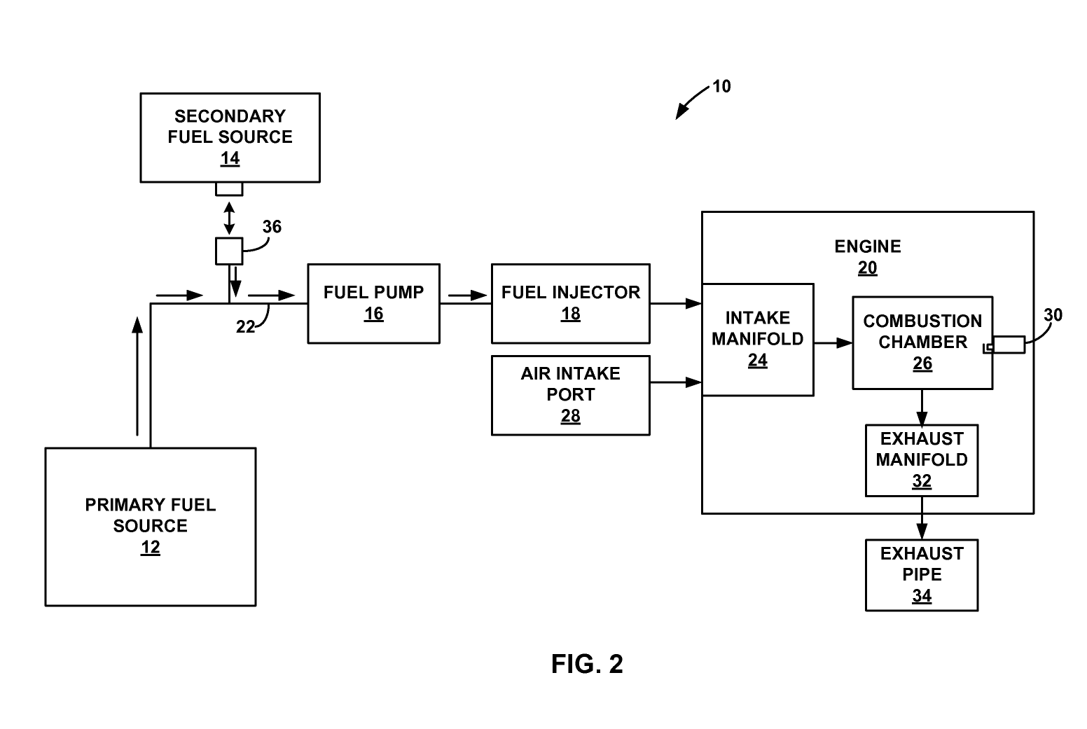

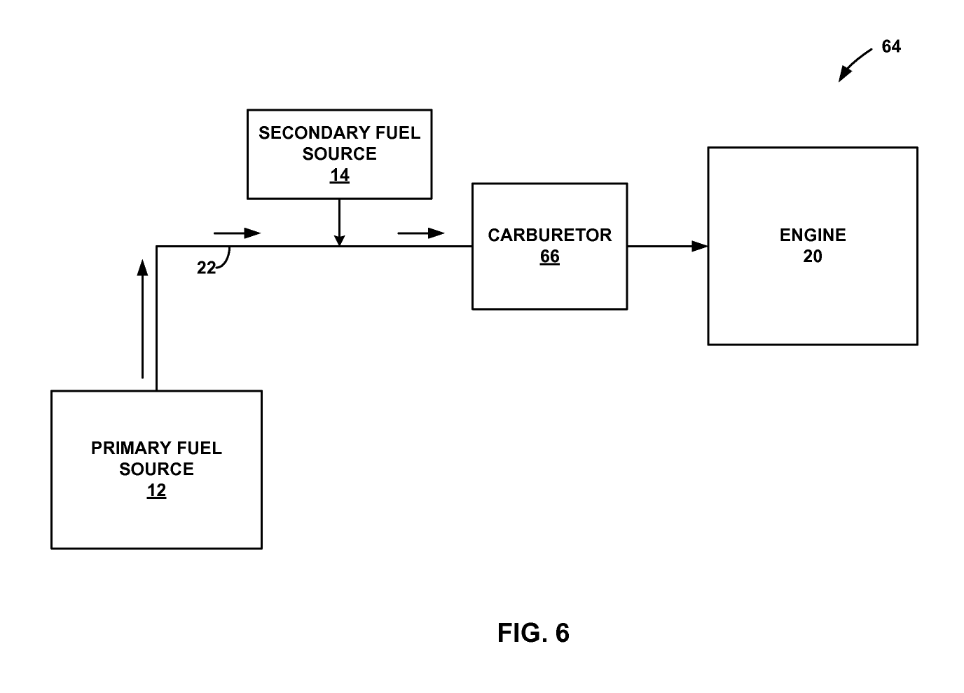

Primary fuel from primary fuel source 12 and a secondary fuel stored by secondary fuel source 14 can be introduced into engine 20 using any suitable technique. In some examples, as described with respect to FIG. 2, a fuel injector and/or fuel pump can be used to introduce fuel into engine 20. In other examples, the fuel can be introduced into engine 20 via a gravity feed, a vacuum feed, or the like. In some examples, both the primary and secondary fuels are introduced directly into an internal combustion chamber of engine 20, although other configurations are contemplated. For example, in the example shown in FIG. 2 and described below, the primary and secondary fuels are introduced into an intake manifold of engine 20 prior to being introduced into the combustion chamber. As another example, if engine 20 includes a carburetor, the primary and secondary fuels can be directly introduced into a fuel line that feeds into the carburetor, as shown in FIG. 6, or indirectly introduced into the fuel line that feeds into the carburetor, e.g., via a fuel pump.

System 8 and engine 20 each includes other components, which are not shown in FIG. 1 for clarity of illustration. For example, engine 20 can include the combustion chamber, a movable component, such as a piston, that generates mechanical energy, an exhaust manifold, and the like.

In some cases, engine 20 may have difficulty starting because of insufficient vaporization of fuel from primary fuel source 12 within a combustion chamber of engine 20. This may occur when engine 20 is in a relatively cold state e.g., when the temperature within the combustion chamber is relatively cold, such that the temperature within the combustion chamber is not high enough to readily vaporize the primary fuel from primary fuel source 12. Difficulty igniting a fuel-air mixture within the combustion chamber of engine 20 may also occur when the external temperature in which engine 20 is operating (e.g., the environment surrounding engine 20, rather than the temperature within the internal combustion chamber) is relatively cold. In some cases, when engine 20 is in a relatively cold state or is operating in a relatively cold external environment, the fuel from primary fuel source 12 may not sufficiently vaporize within engine 20, such that there is an insufficient amount of fuel in the combustion chamber to ignite the fuel-air mixture in the combustion chamber. If the fuel-air mixture with the combustion chamber does not ignite upon initial start-up of engine 20, engine 20 will not start.

Secondary fuel source 14 stores a secondary fuel for starting engine 20, e.g., when engine 20 is in a relatively cold state, when engine 20 is operating in a relatively cold environment or when another operating condition results in an insufficient amount of primary fuel within the combustion chamber of engine 20. In some examples, secondary fuel source 14 stores a liquid, as opposed to a gaseous fuel. The liquid fuel may be more stable than the gaseous fuel. In some examples, secondary fuel source 14 stores a secondary fuel that vaporizes more readily (e.g., is more volatile) than the primary fuel stored by primary fuel source 12. For example, secondary fuel source can store a gasoline-based fuel (e.g., gasoline), while primary fuel source 12 can store a heavy fuel (e.g., diesel or a jet fuel).

Secondary fuel source 14 can be a container (also referred to as a cartridge) that is prefilled with the secondary fuel. A plurality of secondary fuel sources can be prefilled and stored for use with a single engine 20. A user can attach a secondary fuel source 14 to fuel line 22 when start-up of engine 20 is difficult or anticipated to be difficult, e.g., because of the temperature of engine 20 or the operating environment for engine 20. In examples, secondary fuel source 14 can be configured for use with different types of engines. For example, the secondary fuel with which secondary fuel source 14 is prefilled may be useful for starting a two-stroke spark ignition engine as well as a four-stroke spark ignition engine. As another example, the secondary fuel with which secondary fuel source 14 is prefilled may be useful for starting an engine that runs on a primary fuel comprising diesel as well as an engine that runs on a primary fuel comprising jet fuel (e.g., JP5 or JP8).

Secondary fuel supplied by secondary fuel source 14 is useful for initial start-up of engine 20. For example, after engine 20 is turned off and needs to be restarted, a user can fluidically couple secondary fuel source 14 to fuel line 22 and, thereafter, engine 20 can combust the secondary fuel stored within secondary fuel source 14 before combusting primary fuel from primary fuel source 12. Initiating the combustion process of engine 20 with the secondary fuel from secondary fuel source 14 preheats engine 20, such that the temperature within engine 20 is high enough to sufficiently vaporize the primary fuel from primary fuel source 12. After engine 20 is preheated by burning the secondary fuel, engine 20 may begin to combust the primary fuel stored by primary fuel source 12, which may be more energy efficient than the secondary fuel.

The combustion of the secondary fuel generates heat that elevates the temperature within engine. Due to the higher internal temperature of engine 20 compared to the temperature prior to the combustion of the secondary fuel by engine 20, the primary fuel can more readily vaporize within engine 20. In this way, combustion of the secondary fuel from secondary fuel source 14 helps improve the ease with which engine 20 can run off of the primary fuel from primary fuel source 12 and prime engine 20 for operating on the primary fuel. Secondary fuel source 14 is only used to provide fuel during start-up of engine 20. Thus, after the secondary fuel contained within secondary fuel source 14 is consumed, the reliance on secondary fuel source 14 by engine 20 is automatically phased out.

The fuel system of system 8 is modified in order to accommodate secondary fuel source 14. In the example shown in FIG. 1, secondary fuel source 14 is configured to be fluidically connected to the same fuel line 22 that fluidically connects primary fuel source 12 to engine 20. In particular, secondary fuel source 14 is positioned to interrupt fuel line 22, which fluidically connects primary fuel source 12 and engine 20. As a result, engine 20 receives fuel from secondary fuel source 14, if available (e.g., secondary fuel source 14 is not depleted), prior to receiving fuel from primary fuel source 12 because secondary fuel source 14 is the first fuel source available to engine 20. As a result of the physical placement of secondary fuel source 14 relative to primary fuel source 12 and engine 20, engine 20 starts-up using the secondary fuel rather than the primary fuel. That is, secondary fuel from secondary fuel source 14 is introduced into engine 20 before primary fuel from primary fuel source 12 due to the relative location of secondary fuel source 14 between primary fuel source 12 and engine 20. In this way, engine 20 burns secondary fuel before burning primary fuel, enabling engine 20 to start-up using the secondary fuel. Complex fuel control systems that control when the primary and secondary fuels are delivered to engine 20 are not necessary, though they may be used.

Moreover, as described in further detail below, modifying fuel line 22 of system 8 to accommodate secondary fuel source 14 may require less invasive retrofitting of existing engine systems than introducing secondary fuel into engine 20 using a separate fuel line or another type of separate fluid pathway that is separate from the existing fuel line 22 that introduces primary fuel into engine 20. Secondary fuel source 14 can be fluidically coupled to fuel line 22 using any suitable technique. As described with respect to FIG. 2, for example, secondary fuel source 14 can be fluidically coupled to fuel line 22 using a receptacle that defines an opening that receives secondary fuel from secondary fuel source 14 and introduces the secondary fuel into fuel line 22, which then provides the secondary fuel to engine 20. A valve, such as a check valve, can be positioned between primary fuel source 12 and secondary fuel source 14 to help prevent the secondary fuel from feeding into primary fuel source 12.

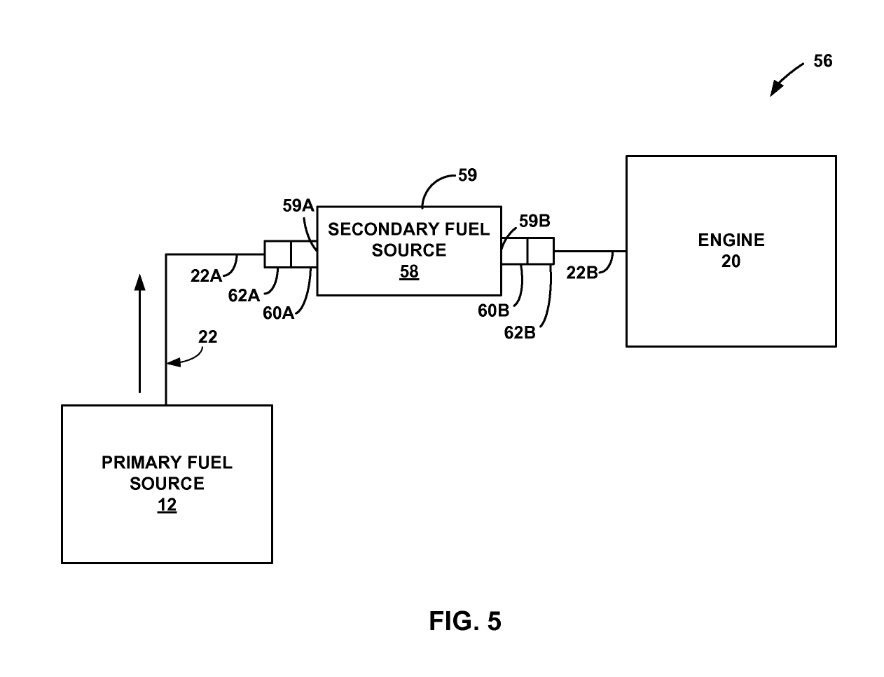

In other examples, as described with respect to FIG. 5, secondary fuel source 14 can be fluidically coupled to fuel line 22 by positioning an outer housing of secondary fuel source 14 to physically interrupt fuel line 22 between primary fuel source 12 and engine 20. Secondary fuel source 14 can be positioned to break-up fuel line 22 into two different portions that are fluidically connected by the outer housing of secondary fuel source 14. Due to the interruption of fuel line 22 by secondary fuel source 14, secondary fuel source 14 can define a conduit through which primary fuel from primary fuel source 12 flows after the secondary fuel is depleted from secondary fuel source 14.

FIG. 2 is a schematic illustration of another example system 10 that includes first and second fuel sources, and, more particularly, primary fuel source 12 and secondary fuel source 14. System 10 further includes fuel pump 16, fuel injector 18, and spark ignition engine 20. As with system 8, system 10 is configured to run on a primary fuel stored by primary fuel source 12, and further includes secondary fuel source 14 that helps initiate an internal combustion process during an initial start-up of engine 20. In some examples, primary fuel source 12 is substantially permanently integrated into system 10, such that removal of primary fuel source 12 is difficult and requires substantial modification to system 10 with the use of tools. In addition, secondary fuel source 14 can be removably attached to system 10, such that secondary fuel source 14 can be more easily removed from system 10 than primary fuel source 12. In some examples, secondary fuel source 14 can be physically separated from system 10 by a user without the aid of tools.

The internal combustion process that takes place within combustion chamber 26 of engine 20 can be used to generate high temperature and pressure gases that apply a force to a moveable component (e.g., a movable piston disposed inside of a cylinder) of engine 20 in order to generate mechanical energy. In some examples, engine system 20 is used to power a vehicle, such as an unmanned aerial vehicle and/or a vertical take-off and landing vehicle. An unmanned aerial vehicle can be a remotely piloted or self-piloted aircraft that can carry cameras, sensors, communications equipment, and/or other payloads.

In some examples, fuel pump 16 and fuel injector 18 are a part of an electrical fuel injection system. Fuel pump 16 and fuel injector 18 deliver a timed injection of fuel from primary fuel source 12 into a combustion chamber of engine 20. Fuel line 22 (which can also be referred to as a fuel conduit) fluidically connects primary fuel source 12 and fuel pump 16. Fuel pump 16 pumps fuel from primary fuel source 12 through fuel line 22, and delivers the primary fuel to fuel injector 18, which pressurizes and, in some cases, atomizes the primary fuel before it is introduced into intake manifold 24 of engine 20. In some examples, fuel injector 18 can be directly coupled to intake manifold 24, which is in communication with combustion chamber 26. In other examples, fuel injector 18 can be directly coupled to combustion chamber 26. Combustion chamber 26 can be proximate a cylinder of engine 20. For example, combustion chamber 24 can be formed in a space surrounded by a cylinder head and the cylinder.

The fuel delivered by fuel injector 18 is mixed with an oxidizer by intake manifold 24, which then supplies the fuel-oxidizer mixture to the cylinders of engine 20. In the example shown in FIG. 2, the oxidizer is air, which is provided by air intake port 28 of engine 20. Air intake port 28 is in fluid communication with intake manifold 24, which, in the example shown in FIG. 2, receives the fuel from fuel injector 18 and the air from air intake port 28 in parallel. A single cylinder of engine 20 is shown in FIG. 2, where the cylinder comprises a single combustion chamber 26. In other examples, engine 20 can include any suitable number of cylinders and respective combustion chambers, and intake manifold 24 can be configured to distribute the fuel-oxidizer mixture to the combustion chambers of any number of cylinder heads. In other examples of system 10, fuel injector 18 directly introduces the primary and secondary fuels into combustion chamber 26.

Once the fuel-air mixture is introduced into combustion chamber 26, a spark, e.g., generated by spark plug 30 of engine 20, initiates the internal combustion process by igniting the mixture of air and vaporized primary fuel within combustion chamber 26. As the fuel-air mixture combusts within internal combustion chamber 26, the high temperature, high pressure gases generated from the combustion apply a force to a moveable component (not shown in FIG. 2) of engine 20 in order to generate mechanical energy.

Engine 20 further comprises exhaust manifold 32 and exhaust valve 34. Exhaust manifold 32 is in fluid communication with combustion chamber 26, as well as the other combustion chambers of engine 20 if engine 20 includes more than one cylinder. As is well known, combustion of the air-fuel mixture within combustion chamber 26 generates exhaust. Exhaust manifold 32 collects engine exhaust from combustion chamber 26 (and other combustion chambers if engine 20 includes multiple cylinders) and delivers the exhaust to exhaust pipe 34, which defines a conduit out of engine 20 for the exhaust.

System 10 and engine 20 includes other components, which are not shown in FIG. 2 for clarity of illustration. For example, engine 20 includes a movable component, such as a piston, that generates mechanical energy. As another example, combustion chamber 26 communicates with intake manifold 26 via an intake valve and with an exhaust manifold via an exhaust valve. Any number of intake valves and exhaust valves can be used.

As discussed above, engine 20 may have difficulty starting because of insufficient vaporization of fuel from primary fuel source 12 within combustion chamber 26. That is, in some cases, the spark generated by spark plug 30 is not be able to begin the combustion process (e.g., ignite the primary fuel) within combustion chamber 26 because an insufficient amount of vaporized primary fuel is present in combustion chamber 26. This may occur when engine 20 is in a relatively cold state e.g., when the temperature within combustion chamber 26 is relatively cold, such that the temperature within combustion chamber 26 is not high enough to readily vaporize the primary fuel from primary fuel source 12. Difficulty igniting a fuel-air mixture within combustion chamber 26 of engine 20 may also occur when the external temperature in which engine 20 is operating (e.g., the environment surrounding engine 20, rather than the temperature within internal combustion chamber 26) is relatively cold. In some cases, when engine 20 is in a relatively cold state or is operating in a relatively cold external environment, the fuel from primary fuel source 12 may not sufficiently vaporize within engine 20, such that there is an insufficient amount of fuel in combustion chamber 26 for a spark generated by spark plug 30 to ignite the fuel-air mixture. If the fuel-air mixture with combustion chamber 26 does not ignite upon initial start-up of engine 20, engine 20 will not start.

Secondary fuel source 14 stores a secondary fuel for starting engine 20, e.g., when engine 20 is in a relatively cold state, when engine 20 is operating in a relatively cold environment or when another operating condition results in an insufficient amount of primary fuel within combustion chamber 26. The temperature of engine 20 or the operating environment of engine 20 at which it may be desirable to use secondary fuel source 14 to initiate the combustion process within combustion chamber 26 may differ depending on the type of primary fuel within primary fuel source 12 and the temperature at which the primary fuel vaporizes. As discussed above, in some examples, secondary fuel source 22 stores a secondary fuel that vaporizes more readily (e.g., is more volatile) than the primary fuel stored by primary fuel source 12.

Secondary fuel supplied by secondary fuel source 14 is useful for initial start-up of engine 20. For example, after engine 20 is turned off and needs to be restarted, a user can fluidically couple secondary fuel source 14 to fuel line 22 and, thereafter, engine 20 can combust the secondary fuel stored within secondary fuel source 14 before combusting primary fuel from primary fuel source 14. Initiating the combustion process within combustion chamber 26 of engine 20 with the secondary fuel from secondary fuel source 14 preheats combustion chamber 26, such that the temperature within combustion chamber 26 is high enough to sufficiently vaporize the primary fuel from primary fuel source 12. After engine 20 is preheated by burning the secondary fuel, engine 20 may begin to combust the primary fuel stored by primary fuel source 12, which may be more energy efficient than the secondary fuel.

When secondary fuel source 14 is fluidically coupled to fuel line 22, fuel pump 16 pumps secondary fuel from secondary fuel source 14 prior to pumping primary fuel from primary fuel source 12 due to the interruption of the path between primary fuel source 14 and pump 16 by secondary fuel source 14. Fuel pump 16 provides the secondary fuel from secondary fuel source 14 to fuel injector 18, which introduces the secondary fuel into intake manifold 24, and, therefore, into combustion chamber 26. In some examples, fuel injector 18 provides injects the secondary fuel into intake manifold 24 using the same timing as that used for primary fuel. However, in other examples, fuel injector 18 utilizes a different timing scheme to inject the secondary fuel into intake manifold 24.

A spark generated by spark plug 30 ignites a secondary fuel-air mixture within combustion chamber 26 to begin the internal combustion process that helps generate the high pressure gases that apply a force to a moveable component to generate mechanical energy. Secondary fuel from secondary fuel source 14 vaporizes at a lower temperature that primary fuel from primary fuel source 12. Thus, the possibility that spark plug 30 will ignite a secondary fuel-air mixture within combustion chamber 26, despite a cold engine state or a cold operating environment, is higher than the possibility that the possibility that the spark will ignite a primary fuel-air mixture within combustion chamber 26.

By starting the internal combustion process with the secondary fuel, the temperature within combustion chamber 26 is elevated prior to the introduction of primary fuel from primary fuel source 12 into combustion chamber 26. After fuel pump 16 stops drawing secondary fuel from secondary fuel source 14 (e.g., because secondary fuel source 14 is empty or has been fluidically decoupled from fuel line 22), fuel pump 16 begins pumping fuel from primary fuel source 12 to provide the primary fuel to fuel injector 18. Fuel injector 18 provides the timed injection of the primary fuel into combustion chamber 26, which, subsequent to the combustion of the secondary fuel, has an increased internal temperature (i.e., the temperature within the internal space defined by the combustion chamber 26). The temperature within combustion chamber 26 is higher than the internal temperature that was observed before the combustion of the secondary fuel due to the heat generated by the combustion of the secondary fuel immediately prior to the combustion of the primary fuel.

The combustion of the secondary fuel generates heat that elevates the temperature within combustion chamber 26. Residual heat from combusting the secondary fuel raises temperature within combustion chamber 26. Thus, due to the higher internal temperature of combustion chamber 26 compared to the temperature prior to the combustion of the secondary fuel within the combustion chamber 26, the primary fuel can more readily vaporize within combustion chamber 26. In this way, combustion of the secondary fuel from secondary fuel source 14 helps improve the ease with which engine 20 can run off of the primary fuel from primary fuel source 12 and prime engine 20 for operating on the primary fuel.

Secondary fuel source 14 is only used to provide fuel during start-up of engine 20. Thus, after the secondary fuel contained within secondary fuel source 14 is consumed, the reliance on secondary fuel source 14 by engine 20 is automatically phased out. In the example of engine system 10 shown in FIG. 2, secondary fuel source 14 need not include a separate fuel pump or be pressurized because fuel pump 16, which is connected to first and second fuel sources 12, 14, respectively, in series, will draw the secondary fuel into fuel line 22. In addition, secondary fuel source 14 shares a fuel injector 18 with primary fuel source 12. Because secondary fuel source 14 can share a fuel pump 16 and fuel injector 18 with primary fuel source 12, secondary fuel source 14 provides an efficient, relatively light weight engine starting system compared to a system that would require separate fuel pumps and/or fuel injectors for multiple fuel sources. In addition, because of the automatic phasing out of the secondary fuel upon consumption of the secondary fuel contained within secondary fuel source 14, engine starting using secondary fuel requires minimal to no automated control by, e.g., an engine control unit.

Fuel pump 16 pumps one fuel at a time. While there may be some incidental mixing of the primary and secondary fuels when shifting between fuel sources 14, 16, e.g., immediately after depletion of secondary fuel source 14 or decoupling of secondary fuel source 14 from fuel line 22, fuel pump 16 does not purposefully mix the primary and secondary fuels before injection into intake manifold 24 (or before direct injection into combustion chamber 26 if system 10 does not include intake manifold 24).

The secondary fuel contained by secondary fuel source 14 acts as a chemical preheater for engine 20. While other types of engine heaters can be useful to heat engine 20 in order to enable the primary fuel to better vaporize within combustion chamber 26, secondary fuel source 14 has a lighter weight than many electrical or resistive heaters. Secondary fuel source 14 comprises the weight of the secondary fuel and the housing containing the secondary fuel. On the other hand, electrical and resistive heaters include the weight of the hardware that generates the heat (e.g., electrical coils), as well as a power source for providing the energy to generate the head. The lighter weight of the chemical preheater, i.e., secondary fuel source 14, may provide advantages in certain situations. Reducing the weight of engine system 20 may be desirable in examples in which engine 20 is incorporated in an aerial vehicles (e.g., vertical take-off and landing vehicles, unmanned aerial vehicles, and the like), automotive vehicles, or other vehicles that are propelled into motion by engine 20.

In some cases, it can be desirable reduce the overall weight of the vehicle (aerial or otherwise), whereby the weight of vehicle includes the weight system 10, in order to provide a more efficient engine 20, reduce the amount of fuel that is consumed to operate engine 20, and enable the vehicle to carry more payload. In addition, in some cases, it can be desirable to reduce the overall size of an aerial vehicle in order to increase the number of situations in which the aerial vehicle can be used, as well as the maneuverability of the aerial vehicle. Further, reducing the weight of engine 20 can help reduce the weight of the aerial vehicle, which can be useful in examples in which the aerial vehicle carried relatively long or even short distances by a human, e.g., in a backpack.

Secondary fuel source 14 also reduces the number of modifications that need to be made to engine 20, which can be a commercially available, off-the-shelf engine, compared to electrical or resistive heaters. If electrical or resistive heaters are utilized to help improve the ease with which engine 20 starts, engine 20 may need to be modified to accommodate the electrical or resistive heaters at the desirable locations (e.g., around combustion chamber 26). This may involve modification to the engine housing, as well as the configuration of the engine components. On the other hand, secondary fuel source 14 is removably coupled to fuel line 22 and is not incorporated in engine 20. In some examples, secondary fuel source 14 can be attached to fuel line 22 and removed from fuel line 22 without the aid of tools. For example, as described in further detail below, secondary fuel source 14 can be attached to fuel line 22 via a self-sealing receptacle that is in fluid communication with fuel line 22. As another example, as described with respect to FIG. 5, an outer housing of secondary fuel source 14 can be directly attached to fuel line 22 without a receptacle.

Secondary fuel source 14 is in-line with primary fuel source 12 of engine 20, such that primary and secondary fuel sources 12, 14 share fuel line 22, fuel pump 16, and fuel injector 18, which minimizes the number of modifications to engine system 10 that may be required in order to implement secondary fuel source 14. That is, primary and secondary fuel sources 12, 14, respectively, are connected to fuel pump 16 and fuel injector 18 in series, such that primary and secondary fuel sources 12, 14, respectively, share a pathway to combustion chamber 26.

While secondary fuel source 14 can be directly coupled to combustion chamber 26, e.g., via intake manifold 24 of engine 20, modifying fuel line 22, which can comprise flexible tubing or relatively stiff tubing, may require less time and effort than modifying engine 20. Modifying engine 20 to directly receive secondary fuel from secondary fuel source 14, rather than indirectly receive the secondary fuel via fuel injector 18, e.g., as shown in FIG. 2, can require drilling into a wall of engine 20 (e.g., drilling into a wall of intake manifold 24). The modification to fuel line 22 to receive secondary fuel from secondary fuel source 14 can be more easily reversible than drilling into a wall of engine 20. For example, fuel line 22 can be replaced or sealed if an opening to receive the secondary fuel from secondary fuel source 14 is no longer necessary.

Secondary fuel source 14 can be located outside of a housing of engine 20. In the example shown in FIG. 2, secondary fuel source 14 is removably coupled to fuel line 22 via receptacle 36, which is fluidically coupled to fuel line 22. In some examples, receptacle 36 is in direct fluid communication with fuel line 22. Receptacle 36 defines an opening through which the secondary fuel flows from secondary fuel source 14 to fuel line 22. A check valve or another valve can be positioned between primary fuel source 12 and receptacle 36 to help prevent the secondary fuel from flowing into primary fuel source 12.

In some examples, the opening defined by receptacle 36 is a self-sealing opening. For example, receptacle 36 can comprise a seal that includes layer of vulcanized rubber and a layer of untreated rubber that expands when moistened by a liquid, such as the secondary fuel. Secondary fuel source 14 can include a feature (e.g., a sharpened point) that punctures the seal in order to introduce the secondary fuel into fuel line 22. Upon removal of secondary fuel source 14 from the seal, the seal may swell and seal the puncture previously formed by secondary fuel source 14. Other types of seal-sealing openings are contemplated.

In other examples, the opening defined by receptacle 36 and positioned between secondary fuel source 14 and fuel line 22 can comprise a movable valve that can be opened and closed to fluidically couple and decouple secondary fuel source 14 from fuel line 22. The opening of the valve can open a fluid channel between secondary fuel source 14 and fuel line 22 and the closing of the valve can close access to fuel line 22, such that secondary fuel source 14 is fluidically decoupled from fuel line 22. In some examples, the valve must be opened prior to introducing secondary fuel source 14 into receptacle 36. In other examples, the valve may be opened and closed while secondary fuel source 14 is introduced in receptacle.

In yet other examples, receptacle 36 can comprise a cap or other cover that can be removed to access an opening through which secondary fuel from secondary fuel source 14 is introduced into fuel line 22. The cap or other cover can be detached from receptacle 36 when secondary fuel source 14 is fluidically coupled to fuel line. After secondary fuel source is removed from receptacle, the cap or other cover can be replaced, such that fuel line 22 is substantially closed and the passageway to fuel line 22 by contaminants is substantially blocked.

Receptacle 36 is configured to receive secondary fuel source 14 and hold secondary fuel source 14 relative to fuel line 22. In some cases, receptacle 36 holds secondary fuel source 14 in a substantially fixed position relative to fuel line 22 (e.g., such that secondary fuel source 14, when received in receptacle 36, does not move relative to fuel line 22). In the example shown in FIG. 2, receptacle 36 is located and oriented such that secondary fuel from secondary fuel source 14 is gravity fed into fuel line 22. However, other arrangements of receptacle 36 and secondary fuel source 14 are contemplated. For example, in some examples, secondary fuel source 14 is pressurized, such that a force other than or in addition to gravity forces the secondary fuel into fuel line 22. Gravity feeding of the secondary fuel into fuel line 22 can be useful, but is not necessary in all examples because fuel pump 16 is configured to pump fuel from secondary fuel source 14 into fuel line 22.

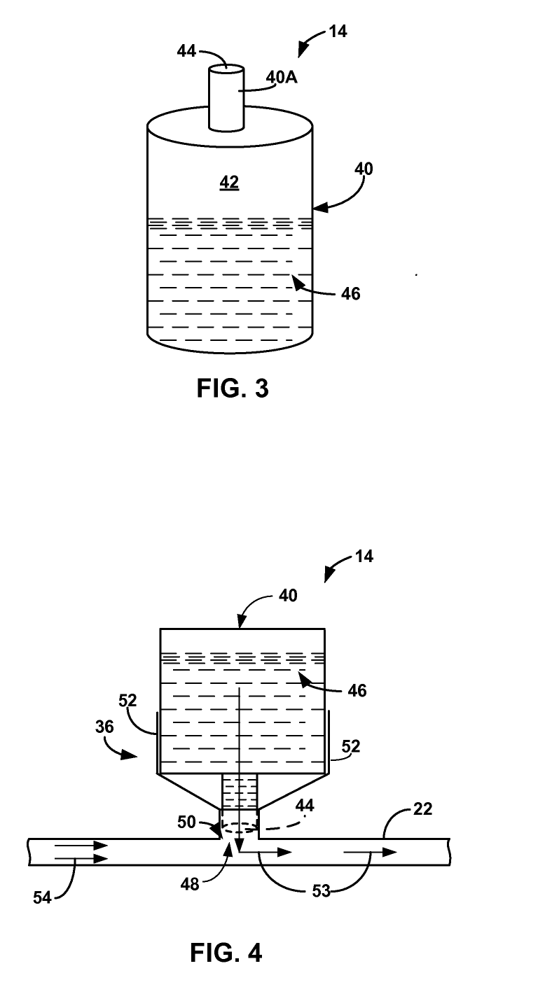

FIG. 3 is a conceptual illustration of an examples secondary fuel source 14. In the example shown in FIG. 3, secondary fuel source 14 comprises outer housing 40 defining cavity 42 for storing secondary fuel 46, where neck 40A of outer housing 40 defines opening 44 through which secondary fuel 46 may exit. In some examples in which receptacle 36 includes a seal, neck 40A can define a sharp edge that punctures the seal.

In some examples, outer housing 40 is comprised of a polymer, metal or another suitable material. Outer housing 40 can be reusable or disposable, in which case outer housing 40 is comprised of a relatively inexpensive material. Outer housing 40 of secondary fuel source 14 can comprise one part or can be made up of multiple parts that are attached to define outer housing 40. Outer housing 40 is relatively small compared to primary fuel source 12 and can contain less than 5% (e.g., about 1%) of the amount of fuel contained by primary fuel source 12, although other relative percentages are contemplated.

In some examples, outer housing 40 is configured to contain a sufficient amount of secondary fuel 46 to start engine 20 and preheat combustion chamber 26 to a temperature that is sufficient to vaporize the primary fuel. This amount of time may be referred to as a warm-up cycle. The warm-up cycle duration and the target temperature to be reached during the warm-up cycle may differ depending upon the type of primary fuel that is being utilized. In some examples, outer housing is configured to contain enough fuel to permit engine 20 to run at idle for about a minute off the secondary fuel or another time period required to bring engine 20 to a sufficient temperature to burn a heavy fuel. In some examples, outer housing 40 can be configured to hold about 30 milliliters of the secondary fuel, although other volumes are contemplated.

For example, outer housing can be about 5 centimeters (about two inches) long and have a diameter of about 5 centimeters (about 2 inches). However, other outer housing sizes for containing other volumes of fuel are contemplated and can be modified depending on the particular engine 20, the particular conditions in which engine 20 is started (e.g., the operating environment), and other factors. Moreover, although a cylindrical outer housing 40 is shown in FIG. 3, in other examples, secondary fuel source 14 may comprise an outer housing having any suitable shape.

FIG. 4 is a conceptual illustration of secondary fuel source 14 removably coupled to receptacle 36, which is in fluid communication with fuel line 22. Receptacle 36 can be attached to fuel line 22 using any suitable technique, such as, but not limited to, an adhesive, welding, and the like. In some examples, opening 48 is defined in a longitudinally-extending wall of fuel line 22, and an opening 50 defined at one end of receptacle 36 are aligned, such that liquid may flow through opening 50 and into fuel line 22 through opening 48.

As shown in FIG. 4, housing 40 of secondary fuel source 14 is introduced into receptacle 36. Walls 52 of receptacle 36 define a space in which housing 40 fits. Walls 52 of receptacle 36 can, but need not, define a space that has a similar geometrical configuration as housing 40 of secondary fuel source 14. For example, if housing 40 has a substantially cylindrical shape, walls 52 of receptacle 36 can define a space in which the cylinder can sit. In some examples, a user can manually place housing 40 of secondary fuel source 14 into receptacle 36 such that opening 44 defined by housing 40 faces fuel line 22. Placement of secondary fuel source 14 in this manner may align opening 44 with openings 50, 48 in receptacle and fuel line 22, respectively. If neck 40A of outer housing 40 of secondary fuel source 14 is configured to puncture a seal of receptacle 36, the user can apply a force toward fuel line 22 when placing housing 40 of secondary fuel source 14 into receptacle 36 such that neck 40A punctures the seal.

In the example shown in FIG. 4, housing 40 is positioned in receptacle 36 such that opening 44 defined by neck 40A of housing 40 is in fluid communication with both opening 48 defined by fuel line 22 and opening 50 defined by receptacle 36. In this way, secondary fuel 46 can flow from housing 40 into fuel line 22, as indicated by arrows 53 shown in FIG. 4. Arrows 53 point in the direction of fuel injector 18. Double arrow 54 shown in FIG. 4 indicates the flow of primary fuel from primary fuel source 12 after secondary fuel 46 is consumed and housing 40 is empty.

In some examples, housing 40 of secondary fuel source 14 is secured to receptacle 36 (e.g., using any suitable mechanical securing technique, such as a cap that is positioned to enclose housing 40 within receptacle 36 or via a removable strap, adhesive, and the like). In other examples, housing 40 merely sits within receptacle 36 and remains engaged with receptacle 36 via, e.g., gravitational forces, and without the aid of an attachment mechanism to secure housing 40. If engine 20 is a part of a moving vehicle, it may be desirable to secure housing 40 to receptacle.

In some examples, system 10 does not include receptacle 36 and secondary fuel source 14 is directly fluidically coupled to fuel line 22. For example, neck 40A of secondary fuel source 14 can be introduced directly into opening 48 of fuel line 22. Fuel line 22 can include a seal-sealing opening or a valve, e.g., as described above with respect to receptacle 36, such that the primary fuel does not leak from opening 48 after removal of secondary fuel source 14 therefrom. Other techniques for fluidically connecting secondary fuel source 14 and fluid line 22 are contemplated.

FIG. 5 is a schematic illustration of another example system 56, which primary fuel source 12 and secondary fuel source 58. System 56 is similar to system 8 of FIG. 1 or system 10 of FIG. 2. Secondary fuel source 58 is similar to secondary fuel source 14 of systems 8, 10, but includes outer housing 59 that defines a conduit that fluidically connects two portions of fuel line 22. As with secondary fuel source 14, secondary fuel source 58 and primary fuel source 12 are connected in series with engine 20. However, in the example shown in FIG. 5, housing 59 of secondary fuel source 58 is positioned to directly interrupt fuel line 22, which fluidically connects primary fuel source 12 with engine 20. In this way, when secondary fuel source 58 is fluidically and mechanically connected to fuel line 22, housing 59 of secondary fuel source 58 divides fuel line 22 into first portion 22A and second portion 22B. First portion 22A of fuel line 22 extends from primary fuel source 12 to secondary fuel source 58 and second portion 22B extends from secondary fuel source 58 to engine 20. Both portions 22A, 22B of fuel line 22 in combination with outer housing 59 of secondary fuel source 14 fluidically couple primary fuel source 12 to engine 20.

In order to start engine 20, e.g., in a cold climate or when engine 20 is in a relatively cold state, a user can connect secondary fuel source 58 to fuel line 22. In some examples, prior to connection of housing 59 of secondary fuel source 58 to fuel line 22, fuel line 22 can be configured to include portions 22A, 22B connected by another, predefined fuel line portion positioned therebetween. The third fuel line portion positioned between portions 22A, 22B can be formed of the same or different material as fuel line portions 22A, 22B, and may include the same or different diameters (if fuel line 22 is circumferential in cross-section). Alternatively, an empty housing 59 of a secondary fuel source 58 (e.g., a previously used secondary fuel source) can be positioned between portions 22A, 22B of fuel line 22 prior to connection of secondary fuel source 58 storing the secondary fuel. In yet another example, portions 22A, 22B of fuel line 22 can be directly connected to each other prior to connecting housing 59 to fuel line 22. In these examples, the user can disconnect the third fuel line portion, empty housing 59 or other conduit coupling fuel line portions 22A, 22B, and replace the removed third fuel line portion, empty housing 59 or other conduit with secondary fuel source 58 that stores a secondary fuel. Alternatively, the user can disconnect fuel line portions 22A, 22B from each other, and position secondary fuel source 58 between fuel line portions 22A, 22B.

Housing 59 of secondary fuel source 58 defines first opening 59A that is configured to fluidically couple to first portion 22A of fuel line 22, and second opening 59B that is configured to fluidically couple to second portion 22B of fuel line 22. Any suitable type of mechanical connection (e.g., a snap-fit or another quick fitting pipe coupling) that provides a fluid-tight seal can be used to mechanically couple first portion 22A of fuel line 22 with opening 59A and second portion 22B of fuel line 22B of fuel line 22 with opening 59B. In the example shown in FIG. 5, connector 60A is connected to opening 59A and connector 60B is connected to opening 59B. Connectors 60A, 60B define respective apertures through which fluid may flow into the respective openings 59A, 59B of housing 59.

In the example shown in FIG. 5, self-sealing connectors 60A, 60B are configured to mate with a respective seal-sealing connector 62A, 62B that is connected to fuel line 22 to define self-sealing connections between fuel line 22 and secondary fuel source 58. In particular, connector 60A is configured to mate with connector 62A to define a seal-sealing connection and seal-sealing connector 60B is configured to mate with self-sealing connector 62B to define a seal-sealing connection that mechanically and fluidically connect secondary fuel source 58 to fuel line 22. Connectors 60A, 60B and connectors 62A, 52B can each define any suitable connection type, such as the ones described above with respect to receptacle 36 (FIG. 4). For example, in some cases, connector 62A defines a feature that punctures a seal defined by connector 60A, and connector 60B defines a feature that punctures a seal defined by connector 62B. Upon removal of connector 62A from connector 60A, the seal defined by connector 60A may swell and seal the puncture previously formed by connector 62A. Similarly, upon removal of connector 60B from connector 62B, the seal defined by connector 62B may swell and seal the puncture previously formed by connector 60B. In other examples, connector 60A defines a feature that punctures a seal defined by connector 62A, and connector 62B defines a feature that punctures a seal defined by connector 60B.

Other types of seal-sealing openings are contemplated. For example, each pair of mating connectors 60A, 60B, 62A, 62B can comprise self sealing quick disconnectors with a pierceable membrane, self-sealing couplers, connectors with valves that are biased closed and held in an open position by a member of the mating connector.

Once housing 59 is mechanically connected to fuel line 22, opening 59A of housing 59 is in fluid communication with portion 22A of fuel line 22 and opening 59B of housing 59 is in fluid communication with portion 22B of fuel line 22. A fluid (e.g., primary fuel) can then freely flow from portion 22A of fuel line 22, through housing 59, and through portion 22B of fuel line 22 to engine 20. In addition, a fluid (e.g., secondary fuel) can then freely flow from housing 59 of secondary fuel source 58 and through portion 22B of fuel line 22 to engine 20.

In some examples, housing 59 of secondary fuel source 58 has a different cross-sectional size and/or shape than fuel line 22 (e.g., housing 59 has a larger cross-sectional size than fuel line 22). In other examples, housing 59 and fuel line 22 have substantially similar cross-sectional shapes and sizes. However, in either case, openings 59A, 59B defined by housing 59 of secondary fuel source 58 are configured to mechanically connect to fuel line portions 22A, 22B, respectively.

A valve (e.g., a check valve) can be positioned at opening 59A, and, in some examples, opening 59B, in order to define a direction of fluid flow from primary fuel source 12 to engine 20, and prevent fluid flow in the opposite direction (i.e., from engine 20 to primary fuel source through housing 59). When housing 59 contains a secondary fuel, the secondary fuel within housing 59 is introduced into engine 20 before primary fuel from primary fuel source 12 is introduced into engine 20 by virtue of the location of secondary fuel source 58 between primary fuel source 12 and engine 20. For example, if system 56 includes fuel pump 16, fuel pump 16 will draw any available secondary fuel from secondary fuel source 58 into second fuel line portion 22B before drawing primary fuel into second fuel line portion 22B. In addition, if system 56 includes fuel injector 18, fuel injector 18 introduces any available secondary fuel from secondary fuel source 58 into engine 20 before introducing primary fuel from primary fuel source 12 into engine 20 because secondary fuel source 58 is the first available fuel source available to the fuel injector.

After secondary fuel source 58 is depleted, housing 59 can remain connected to fuel line portions 22A, 22B. The empty housing 59 can then define a conduit through which primary fuel flows from primary fuel source 12 to engine 20. In other examples, however, a user can mechanically disconnect housing 59 from first and second portions 22A, 22B, respectively, of fuel line 22 and connect first and second portions 22A, 22B of fuel line 22 to each other or replace housing 59 with another conduit (e.g., another fuel line conduit).

As discussed with respect to FIG. 1, a secondary fuel source can be used with any suitable engine fueling system, such as a fueling system that includes a fuel injector or a fueling system that includes a carburetor. FIG. 6 is a schematic illustration of another engine system 64, which is similar to engine system 8 (FIG. 1), but includes carburetor 66. Primary fuel source 12 and secondary fuel source 14 are fluidically connected to carburetor 66 via a common fuel line 22. As discussed with respect to FIGS. 1, 2, and 5, secondary fuel source 14 can be fluidically connected to fuel line 22 using any suitable technique, such as via receptacle 36 (FIG. 2) or by positioning secondary fuel source 14 to interrupt fuel line 22 and fluidically connect separate portions of fuel line 22.

When secondary fuel source 14 is not depleted and stores a secondary fuel, carburetor 66 blends fuel from secondary fuel source 14 with air and provides the air-fuel mixture to an internal combustion chamber of engine 20. Once secondary fuel source 14 is depleted or fluidically decoupled from fuel line 22, carburetor 66 receives the primary fuel from primary fuel source 12 via fuel line 22, blends the primary fuel with air, and provides the air-fuel mixture to an internal combustion chamber of engine 20. Although not shown in FIG. 6, in some examples, engine system 64 can further include a fuel pump that provides one or both secondary fuel from secondary fuel source 14 and/or a primary fuel from primary fuel source 12. In addition, in some examples, secondary fuel source 14 and primary fuel source 12 can include respective fuel pumps that provide fuel to the common fuel line 22 and carburetor 66.

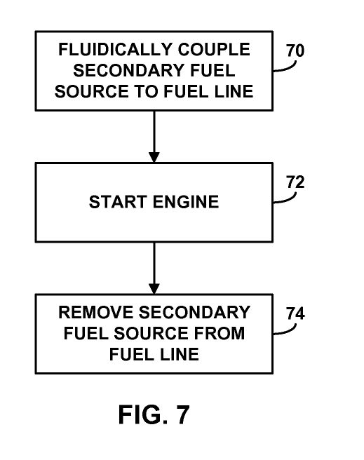

FIG. 7 is a flow diagram illustrating an example technique for starting engine 20 using secondary fuel source 14. In the example technique shown in FIG. 7, a secondary fuel source is removably fluidically connected to fuel line 22 (shown in FIGS. 1, 2, 4, and 5) of engine system 10 (70). For example, a user can place secondary fuel source 14 in receptacle 36, which is in fluid communication with fuel line 22, such that opening 44 (FIG. 3) defined by neck 40A of outer housing 40 is in fluid communication with respective openings 50, 48 of receptacle 36 and fuel line 22. As discussed with respect to FIG. 4, receptacle 36 can be configured to receive and hold outer housing 40 (FIG. 3) of secondary fuel source 14 relative to fuel line 22. In the example shown in FIG. 4, receptacle 36 defines walls 52 that define an opening configured to receive outer housing 40 and engage with at least a portion of outer housing 40 to mechanically support outer housing 40. As a result, the user can place outer housing 40 of secondary fuel source 14 between walls 52 of receptacle 36 in order to fluidically couple secondary fuel source 14 to fuel line 22.

As another example of how secondary fuel source can be fluidically coupled to fuel line 22, a user can position housing 59 of secondary fuel source 58 (FIG. 5) between to interrupt fuel line 22. As discussed with respect to FIG. 5, this may require removing an existing secondary fuel source housing 59 from fuel line 22, removing a predefined portion of fuel line 22 from fuel line 22, splicing fuel line 22, or disconnecting fuel line portions 22A, 22B from each other. The user can then fluidically couple first portion 22A of fuel line 22 to opening 59A of housing 59 and fluidically couple second portion 22B of fuel line 22 to opening 5B of housing 59.

Secondary fuel source 14 can be fluidically coupled to fuel line 22 (70) at any suitable time. In some examples, a user fluidically couples secondary fuel source to fuel line 22 upon initial start-up of engine 20. Engine 20 can be in a cold state at initial start-up (e.g., the temperature of internal combustion chamber 26 may be below the temperature at which the primary fuel readily vaporizes) and/or engine 20 can be started in a relatively cold environment, such that start-up of engine 20 running on a heavy fuel is difficult.

After secondary fuel source 14 is fluidically coupled to fuel line 22 (70), the user may start engine 20 (72), e.g., by turning an ignition or taking another action that results in the generation of a spark by spark plug 30 (FIG. 2). If the system includes a fuel pump, fuel pump 16 (FIG. 2) pumps secondary fuel 46 (FIG. 3) from outer housing 40 and through fuel line 22 to fuel injector 18 (FIG. 2). Thus, after starting of engine 20, fuel injector 18 pumps secondary fuel 46 into intake manifold 24, which mixes secondary fuel 46 with air provided by air intake port 28 (FIG. 2) and provides the air-fuel mixture to combustion chamber 26. When secondary fuel source 14 is fluidically coupled to fuel line 22 and housing 40 of secondary fuel source 14 contains secondary fuel 46 (i.e., housing 40 is not empty), fuel injector 18 provides secondary fuel 46 to intake manifold 24 in lieu of providing primary fuel from primary fuel source 12 to fuel injector 18 because secondary fuel source 14 is positioned to interrupt the fluid communication between primary fuel source 12 (FIG. 2) and fuel pump 16 and fuel injector 18.

Fuel pump 16 is configured to draw fuel from secondary fuel source 14 prior to drawing primary fuel from primary fuel source 12. For example, secondary fuel source 14 can be somewhat pressurized or gravity fed so that when secondary fuel source 14 is engaged in fuel line 22, the secondary fuel is forced into fuel line 22. As another example, a check valve or another valve can be positioned between secondary fuel source 14 and fuel line 22 can be used to preferentially feed the secondary fuel into engine 20 over the primary fuel when secondary fuel source 14 is coupled to fuel line 22. Thus, fuel injector 18 does not inject primary fuel into intake manifold 24 until there is no longer a fuel source (e.g., secondary fuel source 14 is removed or is empty) interrupting the fluid connection between primary fuel source 12 and fuel injector 18.

Within intake manifold 24 and/or combustion chamber 26, secondary fuel 46 vaporizes and the spark generated by spark plug 30 ignites the air-fuel mixture, which initiates the internal combustion process that drives engine 20. As described above with respect to FIG. 2, starting engine 20 with secondary fuel 46, which vaporizes more easily than the primary fuel, can provide a more reliable start-up in some cases, such as when engine 20 is starting in a cold state and/or when engine 20 is operating in a relatively cold environment that is not conducive to vaporization of the heavier primary fuel.

In some examples, a system may not include a fuel pump or fuel injector. In such examples, after secondary fuel source is fluidically coupled to fuel line 22 and after the user starts engine 20 (72), the secondary fuel is introduced through fuel line 22 to engine 20 using any suitable technique, such as using a vacuum force generated by a vacuum generated within engine 20, using a gravity feed from the secondary fuel source into engine 20, or the like.

After outer housing 40 is emptied by fuel pump 16 and/or after engine 20 has been sufficiently warmed up, secondary fuel source 14 can be removed from receptacle 36 (74). In other examples, the secondary fuel source 14 can remain mechanically coupled to receptacle 36 (e.g., during the duration of the flight of the aerial vehicle). However, in examples in which weight reduction of a vehicle in which engine 20 is located may provide advantages (e.g., better maneuverability), it may be desirable to remove secondary fuel source 14 after engine warm-up in order to reduce the vehicle payload.

Various examples have been described in the disclosure. These and other examples are within the scope of the following claims.

1. A system comprising:
a spark ignition engine;
a first fuel source that stores a first type of fuel;
a second fuel source that stores a second type of fuel that is more volatile than the first type of fuel; and
a fuel line that fluidically connects the first and second fuel sources with the spark ignition engine.

2. The system of claim 1, wherein the first type of fuel comprises a heavy fuel.

3. The system of claim 1, wherein the second type of fuel comprises a gasoline based fuel.

4. The system of claim 1, further comprising a receptacle that fluidically connects the second fuel source to the fuel line.

5. The system of claim 4, wherein the receptacle defines a self-sealing opening through which the second type of fuel flows from the second fuel source to the fuel line.

6. The system of claim 4, wherein the receptacle is configured to hold the second fuel source such that the second type of fuel is gravity fed from the second fuel source to the fuel line.

7. The system of claim 1, wherein the second fuel source comprises an outer housing that stores the second type of fuel, and wherein the outer housing fluidically connects a first portion of the fuel line with a second portion of the fuel line.

8. The system of claim 1, further comprising a fuel injector that provides the fuel from the first and second fuel sources to the engine, wherein the second fuel source is positioned between the fuel injector and the first fuel source.

9. The system of claim 8, further comprising a fuel pump that pumps the fuel from the first and second sources and provides the fuel to the fuel injector.

10. The system of claim 9, wherein the fuel pump is configured to pump the second type of fuel from the second fuel source until the second fuel source is at least one of fluidically decoupled from the fuel line or until the second fuel source is empty, and prior to pumping the first type of fuel from the first fuel source.

11. A system comprising:
a spark ignition engine;
a primary fuel source that stores a primary fuel;
a secondary fuel source that stores a secondary fuel different than the primary fuel; and
a pump that pumps the fuel from the first and second fuel sources to the engine, wherein the first and second fuel sources are connected to the pump in series.

12. The system of claim 11, wherein the first type of fuel comprises a heavy fuel and the second type of fuel comprises a gasoline based fuel.

13. The system of claim 11, further comprising a fuel line that fluidically connects the primary and secondary fuel sources with the fuel pump and a receptacle that fluidically connects the secondary fuel source to the fuel line.

14. The system of claim 11, wherein the secondary fuel source comprises an outer housing that stores the secondary fuel, the system further comprising a fuel line that fluidically connects the primary and secondary fuel sources with the engine, wherein the outer housing of the secondary fuel source fluidically connects a first portion of the fuel line with a second portion of the fuel line.

15. A method comprising:
fluidically connecting a removable fuel source to a fuel line, wherein the fuel line fluidically connects a primary fuel source to an engine; and
starting the engine with a secondary fuel contained by the removable fuel source, wherein after removal of the removable fuel source from the fuel line or after depletion of the secondary fuel from the removable fuel source, the engine runs on the primary fuel contained by the primary fuel source.

16. The method of claim 15, further comprising, after starting the engine with the secondary fuel, removing the removable fuel source from the fuel line, wherein the engine runs on the primary fuel contained by the primary fuel source after removal of the removable fuel source from the fuel line.

17. The method of claim 15, wherein fluidically connecting the removable fuel source to the fuel line comprises fluidically connecting the removable fuel source to a receptacle that is in direct fluid communication with the fuel line.

18. The method of claim 15, wherein fluidically connecting the removable fuel source to the fuel line comprises fluidically connecting the removable fuel source to the fuel line in an orientation that gravity feeds the secondary fuel into the fuel line.

19. The method of claim 15, wherein fluidically connecting the removable fuel source to the fuel line comprises fluidically connecting the removable fuel source to the fuel line at a location between the primary fuel source and the engine.

20. The method of claim 19, wherein fluidically connecting the removable fuel source to the fuel line comprises interrupting the fuel line with an outer housing of the removable fuel source, wherein the outer housing of the removable fuel source fluidically connects a first portion of the fuel line with a second portion of the fuel line.
